(19) United States
(12) Patent Application Publication
(10) Pub. No.: US 2024/0022099 A1
(43) Pub. Date: Jan. 18, 2024

(54) STORAGE BATTERY CONTROL DEVICE, POWER STORAGE SYSTEM, AND STORAGE BATTERY CONTROL METHOD

(71) Applicant: YAZAKI CORPORATION, Tokyo (JP)

(72) Inventor: Takahiro Syouda, Susono-shi (JP)

(21) Appl. No.: 18/338,256

(22) Filed: Jun. 20, 2023

(30) Foreign Application Priority Data
Jul. 12, 2022 (JP) 2022-111647

(51) Int. Cl. H02J 7/00; H01M 10/48; H01M 10/44

(52) U.S. Cl. CPC H02J 7/0063; H01M 10/48; H02J 7/00712; H01M 10/441; H02J 7/0048; H02J 7/005; H02J 7/0016

(57) ABSTRACT

A storage battery control device controls a power storage system including a plurality of storage battery strings connected in parallel to each other, each of the storage battery strings including a plurality of storage batteries connected in series and a power converter configured to convert an input/output power of the storage battery string. An instruction value of power or current of charge or discharge of the storage batteries string is set, and when the instruction value changes from a current value to a target value, a process of changing the instruction value to the target value by a small amount of change that is less than a difference between the target value and the current value is repeatedly executed until the instruction value reaches the target value.

### CROSS-REFERENCE TO RELATED APPLICATION(S)

This application is based upon and claims the benefit of priority from prior Japanese patent application No. 2022-111647 filed on Jul. 12, 2022, the entire contents of which are incorporated herein by reference.

### BACKGROUND

### 1. Field of the Invention

The present disclosure relates to a storage battery control device, a power storage system, and a storage battery control method.

### 2. Description of the Related Art

There is known a power storage system including: a plurality of storage battery strings connected in parallel to a DC bus; and a plurality of power converters that are provided for the storage battery strings, respectively (for example, refer to JP2014-79164A). In the power storage system described in JP2014-79164A, an output value of each of the storage battery strings is controlled such that a voltage value of the DC bus is maintained at a predetermined target voltage value. In the power storage system described in JP2014-79164A, to prevent overdischarge or overcharge of the storage batteries, a range of output values output to the storage battery strings is limited.

In the power storage system described in JP2014-79164A, when the output value of each of the storage battery strings is changed, a rapid change in discharge power may occur. For example, when the output value of one storage battery string is decreased and subsequently the output value of another storage battery string is increased, the current decreases instantaneously. On the other hand, when the output value of one storage battery string is increased and subsequently the output value of another storage battery string is decreased, the current becomes excessive instantaneously. Accordingly, there is a possibility that a target output power as the power storage system cannot be maintained.

### SUMMARY

The present disclosure has been made considering the above-described circumstances, and an object thereof is to provide a storage battery control device, a power storage system, and a storage battery control method, in which in a power storage system where a plurality of storage battery strings are connected in parallel, a current change when an instruction value of power or current of charge or discharge of each of the storage battery strings is changed is prevented and a target charge/discharge power as the power storage system is maintained.

According to an aspect of the present disclosure, there is provided a storage battery control device that controls a power storage system including a plurality of storage battery strings connected in parallel to each other, each of the storage battery strings including a plurality of storage batteries connected in series and a power converter configured to convert an input/output power of the storage battery string, in which: an instruction value of power or current of charge or discharge of the storage batteries string is set; and when the instruction value changes from a current value to a target value, a process of changing the instruction value to the target value by a small amount of change that is less than a difference between the target value and the current value is repeatedly executed until the instruction value reaches the target value.

According to another aspect of the present disclosure, there is provided a power storage system including: a plurality of storage battery strings connected in parallel to each other; and a storage battery control device configured to control the storage battery strings, in which each of the storage battery strings includes: a plurality of storage batteries connected in series; and a power converter configured to convert an input/output power of the storage battery string; and in the storage battery control device, an instruction value of power or current of charge or discharge of the storage battery string is set, and when the instruction value changes from a current value to a target value, a process of changing the instruction value to the target value by a small amount of change that is less than a difference between the target value and the current value is repeatedly executed until the instruction value reaches the target value.

According to still another aspect of the present disclosure, there is provided a storage battery control method that is executed by a storage battery control device for controlling a power storage system including a plurality of storage battery strings connected in parallel to each other, each of the storage battery strings including a plurality of storage batteries connected in series and a power converter configured to convert an input/output power of the storage battery string, the storage battery control method including: setting an instruction value of power or current of charge or discharge of the storage battery string; and repeatedly executing a procedure of changing the instruction value to a target value by a small amount of change that is less than a difference between the target value and the current value until the instruction value reaches the target value when the instruction value changes from a current value to the target value.

According to the present disclosure, in a power storage system where a plurality of storage battery strings are connected in parallel, a current change when an instruction value of power or current of charge or discharge of each of the storage battery strings is changed can be prevented and a target charge/discharge power as the power storage system can be maintained.

### BRIEF DESCRIPTION OF THE DRAWINGS

The present disclosure will become more fully understood from the detailed description given hereinbelow and the accompanying drawing which is given by way of illustration only, and thus is not limitative of the present disclosure and wherein:

FIG. 1 is a circuit diagram showing the summary of a power storage system including a storage battery control device according to one embodiment of the present disclosure;

FIG. 2 is a graph showing, when an instruction value of charge power assigned to a storage battery string changes, a relationship between an elapsed time and the instruction value of charge power;

FIG. 3 is a graph showing, when instruction values of charge power of a plurality of storage battery strings change, a relationship between the instruction value of charge power of each of the storage battery strings and an elapsed time and a relationship between an input power of the entire power storage system and the elapsed time;

FIG. 4 is a flowchart showing a process of changing the instruction value of charge power of the storage battery string;

FIG. 5 is a graph showing, when an instruction value of discharge power assigned to a storage battery string changes, a relationship between an elapsed time and the instruction value of discharge power;

FIG. 6 is a graph showing, when instruction values of discharge power of a plurality of storage battery strings change, a relationship between the instruction value of discharge power of each of the storage battery strings and an elapsed time and a relationship between an output power of the entire power storage system and the elapsed time; and

FIG. 7 is a flowchart showing a process of changing the instruction value of discharge power of the storage battery string.

### DETAILED DESCRIPTION OF THE DISCLOSURE

Hereinafter, the present disclosure will be described using a preferable embodiment. The present disclosure is not limited to the following embodiment, and the embodiment can be appropriately changed within a range not departing from the scope of the present disclosure. In the following embodiment, some components are not shown or are not described. Regarding the details of the techniques that are not described, well-known or commonly known techniques can be applied within a range not causing inconsistency with the contents of the following description.

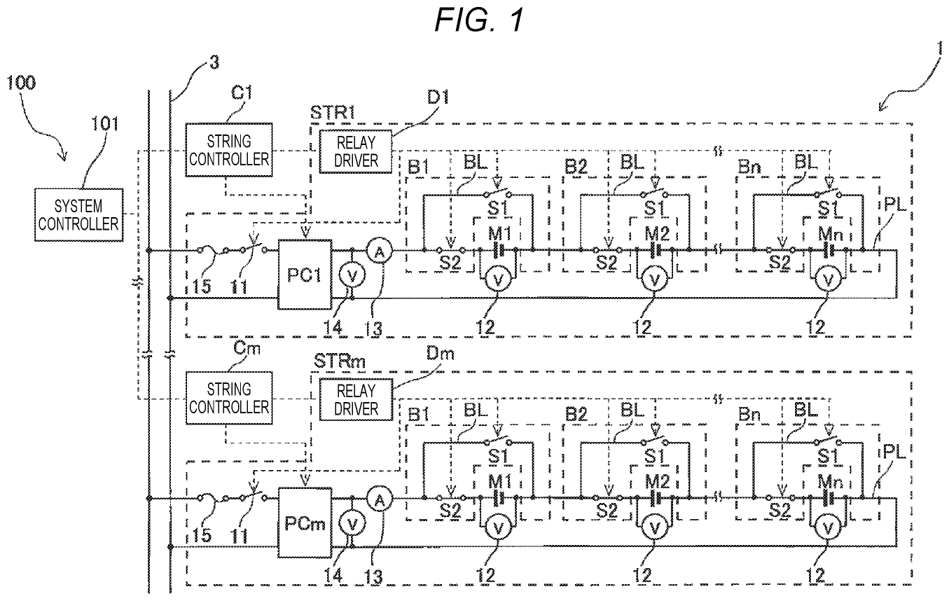

FIG. 1 is a circuit diagram showing the summary of a power storage system 1 including a storage battery control device 100 according to one embodiment of the present disclosure. As shown in the drawing, the power storage system 1 includes m (m represents an integer of 2 or more) storage battery strings STR1 to STRm, a string bus 3, and a storage battery control device 100. The m storage battery strings STR1 to STRm are connected in parallel to each other and are also connected to an external system (not shown) through a string bus 3. The power storage system 1 is a stationary or in-vehicle power supply.

The storage battery strings STR1 to STRm include n (n represents an integer of 2 or more) storage battery modules M1 to Mn connected in series. Although not particularly limited, the storage battery strings STR1 to STRm according to the embodiment are obtained by regenerating used batteries, and there is a difference between the degrees of deterioration of the storage battery modules M1 to Mn. In the storage battery modules M1 to Mn, a plurality of secondary battery cells such as lithium ion batteries or lithium ion capacitors are connected to each other.

The storage battery modules M1 to Mn are charged with power supplied from the external system through a string bus 3 and power converters PC1 to PCm described below. The storage battery modules M1 to Mn supply the power to the external system through the power converters PC1 to PCm and the string bus 3.

The external system includes a load or a power generator. When the power storage system 1 is stationary, a home electrical appliance, a commercial power supply system, a liquid crystal display, a communication module, or the like functions as the load, and a photovoltaic power generation system functions as the power generator. On the other hand, when the power storage system 1 is used in a vehicle, functioning as the load is a drive motor, an air conditioner, various in-vehicle electrical components, or the like. The drive motor functions not only as the load but also as the power generator.

Instead of including the n storage battery modules M1 to Mn connected in series, the storage battery strings STR1 to STRm may include n storage battery cells or storage battery packs connected in series. The power storage system 1 may further include a bypass circuit that bypasses each of the storage battery cells or each of the storage battery packs.

Each of the storage battery strings STR1 to STRm includes one of the power converters PC1 to PCm, one string disconnect switch 11, and n bypass switch units B1 to Bn. Each of the storage battery strings STR1 to STRm includes n voltage sensors 12, one current sensor 13, one voltage sensor 14, one fuse 15, n temperature sensors (not shown), and a plurality of cell voltage sensors (not shown).

The power converters PC1 to PCm are DC/DC converters or DC/AC converters and are connected to the string bus 3. A positive electrode of the storage battery module M1 at a starting end and a negative electrode of the storage battery module Mn at a terminal end are connected to the power converters PC1 to PCm.

The power converters PC1 to PCm convert voltages input from the string bus 3 during the charge of the storage battery strings STR1 to STRm into values corresponding to instruction values of charge power or charge current described below and outputs the converted values to the plurality of storage battery modules M1 to Mn. Here, the voltages of the storage battery strings STR1 to STRm side change depending on bypass states of the storage battery modules M1 to Mn (the number of the bypassed storage battery modules M1 to Mn) or states of charge of the storage battery modules M1 to Mn. Therefore, the power converters PC1 to PCm convert voltages input from the string bus 3 during the charge of the storage battery strings STR1 to STRm into the voltages of the storage battery strings STR1 to STRm side and outputs the converted values to the plurality of storage battery modules M1 to Mn.

The power converters PC1 to PCm convert voltages input from the plurality of storage battery modules M1 to Mn during the discharge of the storage battery strings STR1 to STRm into values corresponding to instruction values of discharge power or discharge current and outputs the converted values to the string bus 3. Here, the input voltages of the power converters PC1 to PCm during discharge change depending on the bypass states of the storage battery modules M1 to Mn and the states of charge of the storage battery modules M1 to Mn. As a result, there is a variation in the input voltages of the power converters PC1 to PCm between the storage battery strings STR1 to STRm during discharge. Here, during the discharge of the storage battery strings STR1 to STRm, the power converters PC1 to PCm convert the input voltages into voltages consistent with the other storage battery strings STR1 to STRm and output the converted values into the string bus 3.

When the current flowing through the string bus 3 is a direct current, the power converters PC1 to PCm are DC/DC converters. When the current flowing through the string bus 3 is an alternating current, the power converters PC1 to PCm 11 are DC/AC converters. When the current flowing through the string bus 3 is an alternating current, the power converters PC1 to PCm include a synchronization unit for following a change in instantaneous value.

The string disconnect switch 11 is provided between each of the power converters PC1 to PCm and the string bus 3. The string disconnect switch 11 connects or disconnects the storage battery strings STR1 to STRm to or from the string bus 3. The fuse 15 is a power fuse that is provided between the string disconnect switch 11 and the string bus 3.

The voltage sensor 12 is connected between positive and negative electrode terminals of each of the storage battery modules M1 to Mn, and transmits a detection signal of a voltage between the terminals of each of the storage battery modules M1 to Mn to string controllers C1 to Cm described below. The current sensors 13 are provided in power lines PL of the storage battery strings STR1 to STRm, and detect charge/discharge currents of the storage battery strings STR1 to STRm and transmit the detection signals to the string controllers C1 to Cm, respectively. The voltage sensors 14 are provided in the power line PL of the storage battery strings STR1 to STRm, and detect a total voltage of the storage battery strings STR1 to STRm and transmit the detection signals to the string controllers C1 to Cm, respectively. The temperature sensors are provided in the storage battery modules M1 to Mn, and detect temperatures of the storage battery modules M1 to Mn and transmit the detection signals to the string controllers C1 to Cm, respectively. The cell voltage sensors are provided in the storage battery modules M1 to Mn, and detect voltages of the storage battery cells and transmit the detection signals to the string controllers C1 to Cm, respectively.

The bypass switch units B1 to Bn are provided in the storage battery modules M1 to Mn, respectively. Each of the bypass switch units B1 to Bn includes a bypass line BL and switches S1 and S2. The bypass line BL is a power line that bypasses each of the storage battery modules M1 to Mn. The switch S1 is provided in the bypass line BL. The switch S1 is, for example, a mechanical switch, a semiconductor switch, or a relay. The switch S2 is provided between the positive electrode of each of the storage battery modules M1 to Mn and one end of the bypass line BL. The switch S2 is, for example, a semiconductor switch or a relay.

The storage battery module M1 at the starting end and the storage battery module Mn at the terminal end are connected to the external system through the power converters PC1 to PCm and the string bus 3. When the switch S1 is OFF and the switch S2 is ON in all of the bypass switch units B1 to Bn, all of the storage battery modules M1 to Mn are connected in series to the external system. On the other hand, when the switch S2 is OFF and the switch S1 is ON in any of the bypass switch units B1 to Bn, the storage battery modules M1 to Mn corresponding to the bypass switch units B1 to Bn are bypassed.

The storage battery control device 100 includes the m string controllers C1 to Cm, m relay drivers D1 to Dm, and one system controller 101. The string controllers C1 to Cm and the relay drivers D1 to Dm are provided in the storage battery strings STR1 to STRm, respectively.

The string controllers C1 to Cm transmit control signals to the relay drivers D1 to Dm and the power converters PC1 to PCm of the corresponding storage battery strings STR1 to STRm. The relay drivers D1 to Dm control the switches S1 and S2 and the string disconnect switch 11 of the corresponding bypass switch units B1 to Bn based on the control signals transmitted from the corresponding string controllers C1 to Cm. The power converters PC1 to PCm convert charge/discharge voltages of the corresponding storage battery strings STR1 to STRm based on the control signals transmitted from the corresponding string controllers C1 to Cm.

The string controllers C1 to Cm execute detection of states of the corresponding storage battery strings STR1 to STRm, estimation of the states of the corresponding storage battery strings STR1 to STRm, notification of a control request for a device to the system controller 101, and the like. Examples of the detection of states of the storage battery strings STR1 to STRm include detection of the charge/discharge currents of the storage battery strings STR1 to STRm based on the detection signals of the current sensor 13, detection of the total voltage of the storage battery strings STR1 to STRm based on the detection signals of the voltage sensors 14, detection of the voltages of the storage battery modules M1 to Mn based on the detection signals of the voltage sensors 12, detection of the temperatures of the storage battery modules M1 to Mn based on the detection signals of the temperature sensors, and detection of the voltages of the storage battery cells based on the detection signals of the cell voltage sensors. Examples of the estimation of the states of the storage battery strings STR1 to STRm include estimation of state of charges (SOCs) or SOHs of the storage battery modules M1 to Mn and estimation of SOCs or SOHs of the storage battery strings STR1 to STRm. Examples of the notification of the control request for the device to the system controller 101 include a request of a switching control of the switches S1 and S2 of the bypass switch units B1 to Bn or the string disconnect switch 11 and a request of a control of the power converters PC1 to PCm.

Examples of a method of estimating the SOH include a method using a charge/discharge test, a method using the current integration method, a method using measurement of an open circuit voltage, a method using measurement of a terminal voltage, a method based on a model (all of which are methods using a change over time in SOC), a method using alternating current impedance measurement, a method of acquiring the SOH using an adaptive digital filter based on a model, a method using linear regression (a from I-V characteristics (a slope of a straight line of I-V characteristics) from I-V characteristics (current-voltage characteristics), and a method using a step response (all of which are estimation methods using an increase over time in internal resistance).

Examples of a method of estimating the SOC include various methods such as the current integration method, a method of acquiring the SOC from an open circuit voltage (OCV) (voltage method), or a combination method of the current integration method and the voltage method. The OCV can be estimated using various well-known estimation methods using a change over time in terminal voltage or an increase over time in internal resistance.

Here, the string controllers C1 to Cm calculate the charge/discharge powers of the corresponding storage battery strings STR1 to STRm and transmit the calculation results to the system controller 101. The charge/discharge power of each of the storage battery strings STR1 to STRm is calculated using the product of the charge/discharge current of each of the storage battery strings STR1 to STRm detected by the current sensor 13 of each of the storage battery strings STR1 to STRm and the total voltage of the storage battery strings STR1 to STRm detected by the voltage sensor 14 of each of the storage battery strings STR1 to STRm.

The system controller 101 is a control that integrally controls the entire power storage system 1 and executes 1 to m communication with the m string controllers C1 to Cm. The system controller 101 executes monitoring of the states of the storage battery strings STR1 to STRm, determination of whether a control request for a device from the string controllers C1 to Cm is suitable, and notification of approval of the control request for the device to the string controllers C1 to Cm. The system controller 101 executes setting of the instruction value of charge/discharge power (charge power and discharge power) or charge/discharge current (charge current and discharge current) of each of the storage battery strings STR1 to STRm and transmission of the instruction value of charge/discharge power or charge/discharge current to the string controllers C1 to Cm.

The system controller 101 monitors the states of the storage battery strings STR1 to STRm based on the detection result or the estimation result of the states of the storage battery strings STR1 to STRm transmitted from the string controllers C1 to Cm. The system controller 101 calculates the instruction value of charge/discharge power or charge/discharge current assigned to each of the storage battery strings STR1 to STRm based on an instruction of input/output power or input/output current of the entire power storage system 1 received from a higher-ranking system (not shown) and the states of the storage battery strings STR1 to STRm.

Here, the system controller 101 determines priorities of the storage battery strings STR1 to STRm to which the instruction values of charge/discharge power or charge/discharge current are assigned depending on the monitored states of the storage battery strings STR1 to STRm. The system controller 101 assigns the instruction value of charge/discharge power or charge/discharge current is assigned to each of the storage battery strings STR1 to STRm according to the determined priorities. For example, there is a case where the system controller 101 assigns an instruction T of charge/discharge power or charge/discharge current to the storage battery strings STR1 to STRm having a higher priority; whereas the system controller 101 does not assign the instruction value of charge/discharge power or charge/discharge current to the storage battery strings STR1 to STRm having a lower priority. There is a case where the system controller 101 assigns a higher instruction T of charge/discharge power or charge/discharge current to the storage battery strings STR1 to STRm having a higher priority; whereas the system controller 101 assigns a lower instruction value of charge/discharge power or charge/discharge current to the storage battery strings STR1 to STRm having a lower priority.

A method of determining the priority includes a method of determining the priority depending on a cumulative charge/discharge capacity of each of the storage battery strings STR1 to STRm, a method of determining the priority depending on the SOH of each of the storage battery strings STR1 to STRm, and a method of randomly determining the priority whenever the charge/discharge power or the charge/discharge current changes. In the method of determining the priority depending on the cumulative charge/discharge capacity of each of the storage battery strings STR1 to STRm, the priority is set to be higher as the cumulative charge/discharge capacity of the storage battery strings STR1 to STRm decreases. In the method of determining the priority depending on the SOH of each of the storage battery strings STR1 to STRm, the priority is set to be higher as the SOH of each of the storage battery strings STR1 to STRm increases.

The string controllers C1 to Cm calculate limit values of charge/discharge power or charge/discharge current based on the SOC or the OCV of the storage battery modules M1 to Mn and transmit the calculation results to the system controller 101. The system controller 101 calculates instruction values of charge/discharge power or charge/discharge current of the storage battery strings STR1 to STRm corresponding to the string controllers C1 to Cm such that the instruction values fall below the limit values of charge/discharge power or charge/discharge current transmitted from the string controllers C1 to Cm.

Here, as a remaining charge capacity until an upper limit threshold of the SOC of the storage battery strings STR1 to STRm (hereinafter, referred to as the string SOC) decreases, a limit value of charge power or charge current decreases. Therefore, by monitoring the limit value of charge power or charge current of the storage battery strings STR1 to STRm, the remaining charge capacity until the upper limit threshold of the string SOC can be monitored. Accordingly, by calculating the charge power or the charge current of the storage battery strings STR1 to STRm such that the charge power or the charge current falls below the limit value of charge power or charge current, the instruction value of charge power or charge current can be assigned to the storage battery strings STR1 to STRm where the remaining charge capacity until the upper limit threshold of the string SOC is present. The upper limit threshold of the string SOC is, for example, 90% or higher and lower than 100%.

Likewise, as a remaining discharge capacity until a lower limit threshold of the string SOC decreases, a limit value of discharge power or discharge current decreases. Therefore, by monitoring the limit value of discharge power or discharge current of the storage battery strings STR1 to STRm, the remaining discharge capacity until the lower limit threshold of the string SOC can be monitored. Accordingly, by calculating the instruction value of discharge power or discharge current of the storage battery strings STR1 to STRm such that the instruction value falls below the limit value of discharge power or discharge current, the instruction value of discharge power or discharge current can be assigned to the storage battery strings STR1 to STRm where the remaining discharge capacity until the lower limit threshold of the string SOC is present. The lower limit threshold of the string SOC is, for example, higher than 0% and 10% or lower.

The system controller 101 determines whether a control request for a device from the string controllers C1 to Cm is approved depending on the monitored states of the other storage battery strings STR1 to STRm. When the system controller 101 approves the control request for the device from the string controllers C1 to Cm, the system controller 101 transmits notification of the approval of the control request to the corresponding string controllers C1 to Cm. The string controllers C1 to Cm, that receives the notification of the approval of the control request for the bypass switch units B1 to Bn or the string disconnect switch 11, execute the switching control of the corresponding bypass switch units B1 to Bn or the corresponding string disconnect switch 11 through the relay drivers D1 to Dm. The string controllers C1 to Cm that receives the notification of the approval of the control request for the power converters PC1 to PCm execute the control of the corresponding power converters PC1 to PCm.

In a situation where a control request for a device is not transmitted from one of the string controllers C1 to Cm, the system controller 101 optionally transmits a control instruction for the device to the corresponding string controllers C1 to Cm. When the string controllers C1 to Cm detect abnormality in the storage battery strings STR1 to STRm, the string controllers C1 to Cm transmit a control signal of disconnecting the string disconnect switch 11 to the relay drivers D1 to Dm regardless of the notification of the control approval or the control instruction from the system controller 101.

Here, in a process of changing the instruction value of charge/discharge power or charge/discharge current assigned to each of the storage battery strings STR1 to STRm, the system controller 101 gradually and continuously changes the instruction value of charge/discharge power or charge/discharge current of each of the storage battery strings STR1 to STRm from a current value to a target value. Hereinafter, the process of changing the instruction value of charge/discharge power or charge/discharge current assigned to each of the storage battery strings STR1 to STRm will be described.

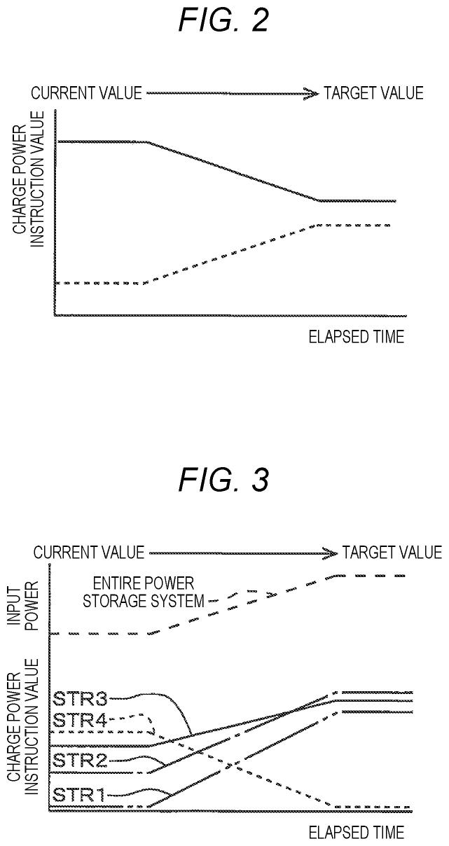

FIG. 2 is a graph showing, when the instruction value of charge power (hereinafter, referred to as the charge power instruction value) assigned to each of the storage battery strings STR1 to STRm changes, a relationship between an elapsed time and the charge power instruction value. The graph shows the example where the charge power instruction value of one of the storage battery strings STR1 to STRm decreases and the charge power instruction value of another one of the storage battery strings STR1 to STRm increases. In the present example, the charge power instruction value assigned to the one of the storage battery strings STR1 to STRm is changed to the other one of the storage battery strings STR1 to STRm.

As indicated by a solid line in FIG. 2, the charge power instruction value of the one of the storage battery strings STR1 to STRm gradually and continuously decreases from the current value to the target value over a predetermined period of time. Likewise, as indicated by a broken line in FIG. 2, the charge power instruction value of the other one of the storage battery strings STR1 to STRm gradually and continuously increases from the current value to the target value over a predetermined period of time.

FIG. 3 is a graph showing, when charge power instruction values of a plurality of storage battery strings STR1 to STR4 change, a relationship between the charge power instruction value of each of the storage battery strings STR1 to STR4 and an elapsed time and a relationship between an input power of the entire power storage system 1 (refer to FIG. 1) and the elapsed time. The graph shows the example where the input power of the entire power storage system 1 increases, the charge power instruction values of the storage battery strings STR1 to STR3 increase, and the charge power instruction value of the storage battery string STR4 decreases. In the present example, the charge power instruction value assigned to the storage battery string STR4 is changed to the storage battery strings STR1 to STR3.

As indicated by a solid line, a one-dot chain line, and a two-dot chain line in FIG. 2, the charge power instruction values of the storage battery strings STR1 to STR3 gradually and continuously increase from a current value to a target value over a predetermined period of time. Likewise, as indicated by a broken line in FIG. 3, the charge power instruction value of the storage battery strings STR4 gradually and continuously decreases from the current value to the target value over a predetermined period of time. As a result, the input power of the entire power storage system 1 gradually and continuously increases from the current value to the target value over a predetermined period of time. To decrease the input power of the entire power storage system 1, the charge power instruction values of all or a part of the storage battery strings STR1 to STRm may be gradually and continuously decreased over a predetermined period of time such that the input power of the entire power storage system 1 gradually and continuously decreases. Here, the storage battery strings STR1 to STRm where the charge power instruction value increases and the storage battery strings STR1 to STRm where the charge power instruction value decreases may be caused to be present together.

Hereinafter, the details of the process of changing the charge power instruction values of the storage battery strings STR1 to STRm will be described. Instead of changing the charge power instruction values of the storage battery strings STR1 to STRm, the instruction values of charge current of the storage battery strings STR1 to STRm may be changed. Here, the same process as a process described below may be executed.

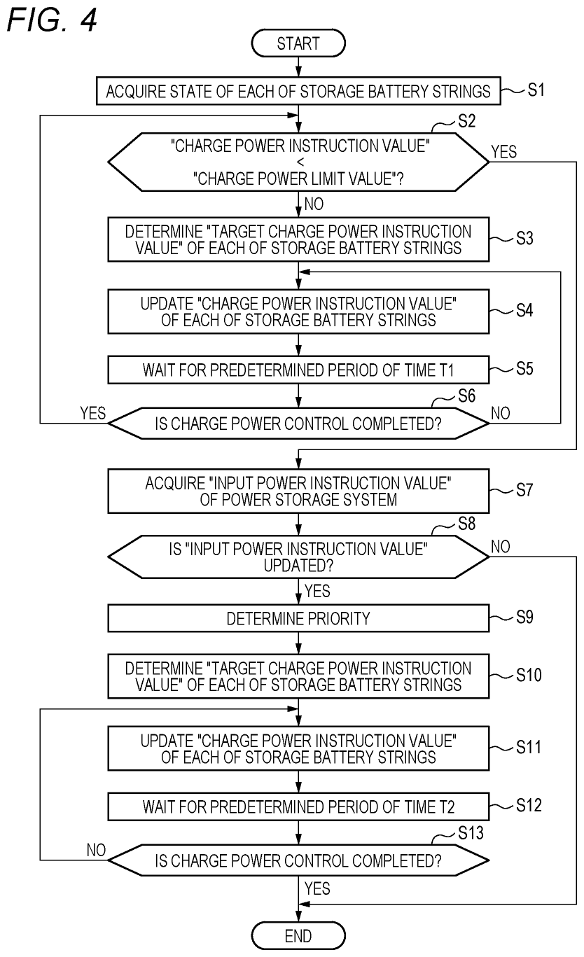

FIG. 4 is a flowchart showing the process of changing the charge power instruction values of the storage battery strings STR1 to STRm. First, in Step S1, the system controller 101 (refer to FIG. 1) acquires latest information (the detection result and the estimation result) of the states of the storage battery strings STR1 to STRm (refer to FIG. 1) from the string controllers C1 to Cm (refer to FIG. 1), respectively. The information includes information regarding the limit value of charge power (hereinafter, referred to as the charge power limit value) of each of the storage battery strings STR1 to STRm.

Next, in Step S2, the system controller 101 determines whether the current charge power instruction value of each of the storage battery strings STR1 to STRm is lower than the current charge power limit value of each of the storage battery strings STR1 to STRm. When YES is determined in Step S2, the process transitions to Step S7. When NO is determined in Step S2, the process transitions to Step S3.

In Step S3, the system controller 101 determines a target charge power instruction value of each of the storage battery strings STR1 to STRm. Specifically, the system controller 101 decreases the charge power instruction values of some of the storage battery strings STR1 to STRm for which NO is determined in Step S2 and increases the charge power instruction values of the other ones of the storage battery strings STR1 to STRm. That is, the storage battery strings STR1 to STRm where the charge power instruction value is the charge power limit value or higher are changed to the storage battery strings STR1 to STRm where the charge power instruction value is lower than the charge power limit value.

Next, the system controller 101 repeatedly executes the loop process of Steps S4 to S6 until the charge power instruction value reaches the target charge power instruction value. Here, in Steps S4 to S6, the system controller 101 changes the charge power instruction value of each of the storage battery strings STR1 to STRm from the current value to the target value gradually and continuously by a predetermined amount ΔP1.

First, in Step S4, the system controller 101 changes the charge power instruction value of each of the storage battery strings STR1 to STRm by the predetermined amount ΔP1. The predetermined amount ΔP1 is set to a small amount to satisfy an object of preventing a rapid change in charge power. When a difference between the current value and the target value of the charge power instruction value is small, the predetermined amount ΔP1 may be the same as the difference between the current value and the target value of the charge power instruction value. On the other hand, when a difference between the current value and the target value of the charge power instruction value is relatively large, the predetermined amount ΔP1 may be less than the difference between the current value and the target value of the charge power instruction value. When the predetermined amount ΔP1 is less than the difference between the current value and the target value of the charge power instruction value, the charge power instruction value is repeatedly updated multiple times.

Next, in Step S5, the system controller 101 waits for a predetermined period of time T1 from the transmission of the charge power instruction value to the string controllers C1 to Cm. The predetermined period of time T1 is set considering a period of time required for the control of the charge power of the storage battery strings STR1 to STRm by the string controllers C1 to Cm and a change rate of charge power. Here, the change rate of charge power is set to be low to satisfy the object of preventing a rapid change in charge power.

Next, in Step S6, the system controller 101 determines whether the current charge power instruction value of each of the storage battery strings STR1 to STRm reaches the target charge power instruction value of each of the storage battery strings STR1 to STRm. When NO is determined in Step S6, the process transitions to Step S4. When YES is determined in Step S6, the process transitions to Step S2.

When the storage battery strings STR1 to STRm where the charge power instruction value is the charge power limit value or higher are present, the loop process of Steps S4 to S6 is repeatedly executed until the charge power instruction value of the corresponding storage battery strings STR1 to STRm falls below the charge power limit value. Here, in Steps S4 to S6, the charge power instruction value of each of the storage battery strings STR1 to STRm changes from the current value to the target value gradually and continuously by the predetermined amount ΔPI.

Next, in Step S7, the system controller 101 acquires an instruction value of input power of the entire power storage system 1 (hereinafter, referred to as the input power instruction value) from the higher-ranking system. Next, in Step S8, the system controller 101 determines whether the input power instruction value acquired in Step S7 is updated from the previously acquired input power instruction value. When YES is determined in Step S8, the process transitions to Step S9. When NO is determined in Step S8, the process ends.

In Step S9, the system controller 101 determines the priorities of the storage battery strings STR1 to STRm to which the charge power instruction values are assigned depending on the state of each of the storage battery strings STR1 to STRm. Next, in Step S10, the system controller 101 calculates and determines the target value of charge power of each of the storage battery strings STR1 to STRm (hereinafter, referred to as the target charge power instruction value) depending on the priorities determined in Step S9. That is, the system controller 101 assigns a higher target charge power instruction value to the storage battery strings STR1 to STRm having a higher priority.

Next, the system controller 101 repeatedly executes the loop process of Steps S11 to S13 until the charge power instruction value reaches the target charge power instruction value. Here, in Steps S11 to S13, the system controller 101 changes the charge power instruction value of each of the storage battery strings STR1 to STRm from the current value to the target value gradually and continuously by a predetermined amount ΔP2.

First, in Step S11, the system controller 101 calculates the predetermined amount ΔP2 and updates the charge power instruction value of each of the storage battery strings STR1 to STRm. The predetermined amount ΔP2 is a value obtained by equally dividing a difference between the target charge power instruction value of each of the storage battery strings STR1 to STRm determined in Step S10 and the current charge power instruction value. Here, the number of times the difference is equally divided is set such that the calculated predetermined amount ΔP2 satisfies the object of preventing a rapid change in charge power.

Next, in Step S12, the system controller 101 waits for a predetermined period of time T2 from the transmission of the charge power instruction value to the string controllers C1 to Cm. The predetermined period of time T2 is set considering a period of time required for the control of the charge power of the storage battery strings STR1 to STRm by the string controllers C1 to Cm and a change rate of charge power. Here, the change rate of charge power is set to be low to satisfy the object of preventing a rapid change in charge power.

Next, in Step S13, the system controller 101 determines whether the current charge power instruction value of each of the storage battery strings STR1 to STRm reaches the target charge power instruction value of each of the storage battery strings STR1 to STRm. When NO is determined in Step S13, the process transitions to Step S11. When YES is determined in Step S13, the process ends.

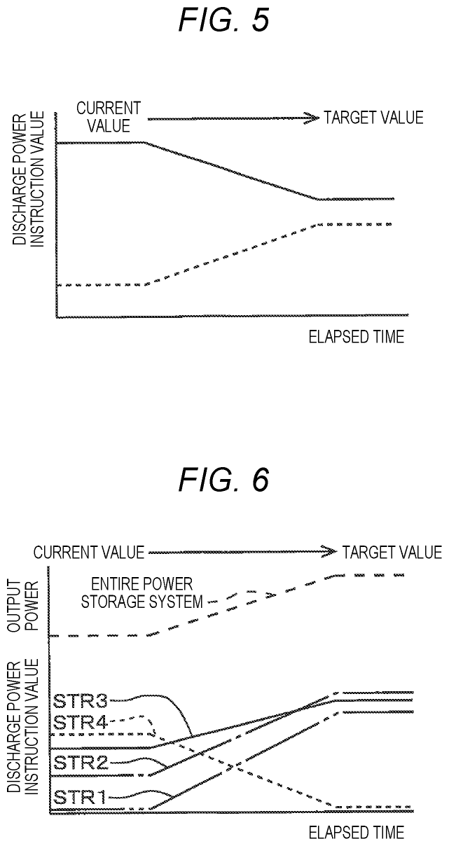

FIG. 5 is a graph showing, when the instruction value of discharge power (hereinafter, referred to as the discharge power instruction value) assigned to each of the storage battery strings STR1 to STRm changes, a relationship between an elapsed time and the discharge power instruction value. The graph shows the example where the discharge power instruction value of one of the storage battery strings STR1 to STRm decreases and the discharge power instruction value of another one of the storage battery strings STR1 to STRm increases. In the present example, the discharge power assigned to the one of the storage battery strings STR1 to STRm is changed to the other one of the storage battery strings STR1 to STRm.

As indicated by a solid line in FIG. 5, the discharge power instruction value of the one of the storage battery strings STR1 to STRm gradually and continuously decreases from the current value to the target value over a predetermined period of time. Likewise, as indicated by a broken line in FIG. 5, the discharge power instruction value of the other one of the storage battery strings STR1 to STRm gradually and continuously increases from the current value to the target value over a predetermined period of time.

FIG. 6 is a graph showing, when discharge power instruction values of a plurality of storage battery strings STR1 to STR4 change, a relationship between the discharge power instruction value of each of the storage battery strings STR1 to STR4 and an elapsed time and a relationship between an output power of the entire power storage system 1 and the elapsed time. The graph shows the example where the output power of the entire power storage system 1 increases, the discharge power instruction values of the storage battery strings STR1 to STR3 increase, and the discharge power instruction value of the storage battery string STR4 decreases. In the present example, the discharge power assigned to the storage battery string STR4 is changed to the storage battery strings STR1 to STR3.

As indicated by a solid line, a one-dot chain line, and a two-dot chain line in FIG. 6, the discharge power instruction values of the storage battery strings STR1 to STR3 gradually and continuously increases from a current value to a target value over a predetermined period of time. Likewise, as indicated by a broken line in FIG. 6, the discharge power instruction value of the storage battery strings STR4 gradually and continuously decreases from the current value to the target value over a predetermined period of time. As a result, the output power of the entire power storage system 1 gradually and continuously increases from the current value to the target value over a predetermined period of time.

Hereinafter, the details of the process of changing the discharge power instruction values of the storage battery strings STR1 to STRm will be described. Instead of changing the discharge power instruction values of the storage battery strings STR1 to STRm, the instruction values of discharge current of the storage battery strings STR1 to STRm may be changed. Here, the same process as a process described below may be executed.

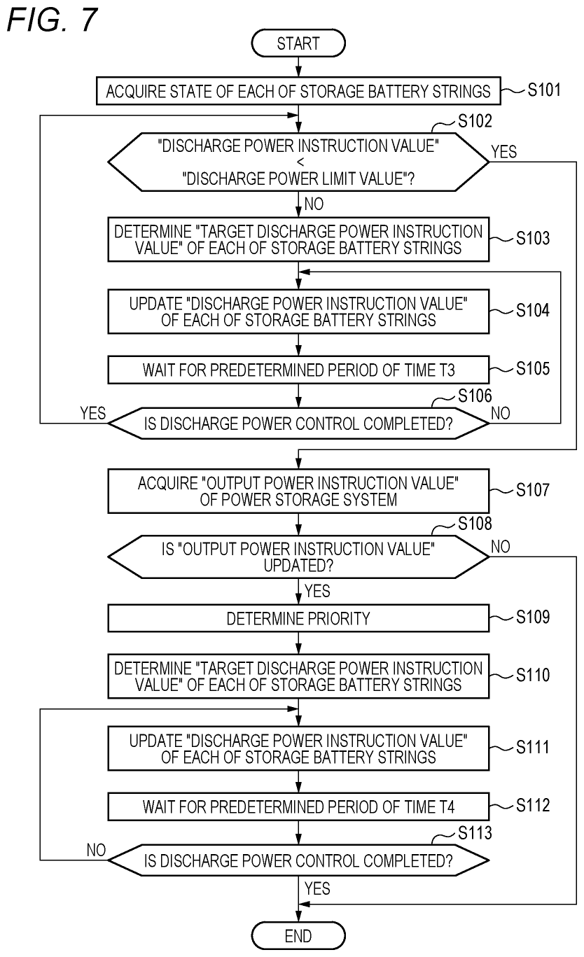

FIG. 7 is a flowchart showing the process of changing the discharge power instruction values of the storage battery strings STR1 to STRm. First, in Step S101, the system controller 101 acquires latest information (the detection result and the estimation result) of the states of the storage battery strings STR1 to STRm from the string controllers C1 to Cm, respectively. The latest information includes information regarding the limit value of discharge power (hereinafter, referred to as the discharge power limit value) of each of the storage battery strings STR1 to STRm.

Next, in Step S102, the system controller 101 determines whether the current discharge power instruction value of each of the storage battery strings STR1 to STRm is lower than the current discharge power limit value of each of the storage battery strings STR1 to STRm. When YES is determined in Step S102, the process transitions to Step S107. When NO is determined in Step S102, the process transitions to Step S103.

In Step S103, the system controller 101 determines a target discharge power instruction value of each of the storage battery strings STR1 to STRm. Specifically, the system controller 101 decreases the discharge power instruction values of some of the storage battery strings STR1 to STRm for which NO is determined in Step S102 and increases the discharge power instruction values of the other ones of the storage battery strings STR1 to STRm. That is, the storage battery strings STR1 to STRm where the discharge power instruction value exceeds the discharge power limit value are changed to the storage battery strings STR1 to STRm where the discharge power instruction value is lower than the discharge power limit value.

Next, the system controller 101 repeatedly executes the loop process of Steps S104 to S106 until the discharge power instruction value reaches the target discharge power instruction value. Here, in Steps S104 to S106, the system controller 101 changes the discharge power instruction value of each of the storage battery strings STR1 to STRm from the current value to the target value gradually and continuously by a predetermined amount ΔP3.

First, in Step S104, the system controller 101 changes the discharge power instruction value of each of the storage battery strings STR1 to STRm by the predetermined amount ΔP3. The predetermined amount ΔP3 is set to a small amount to satisfy the object of preventing a rapid change in discharge power. When a difference between the current value and the target value of the discharge power instruction value is small, the predetermined amount ΔP3 may be the same as the difference between the current value and the target value of the discharge power instruction value. On the other hand, when a difference between the current value and the target value of the discharge power instruction value is relatively large, the predetermined amount ΔP3 may be less than the difference between the current value and the target value of the discharge power instruction value. When the predetermined amount ΔP3 is less than the difference between the current value and the target value of the discharge power instruction value, the discharge power instruction value is repeatedly updated multiple times.

Next, in Step S105, the system controller 101 waits for a predetermined period of time T3 from the transmission of the discharge power instruction value to the string controllers C1 to Cm. The predetermined period of time T3 is set considering a period of time required for the control of the discharge power of the storage battery strings STR1 to STRm by the string controllers C1 to Cm and a change rate of discharge power. Here, the change rate of discharge power is set to be low to satisfy the object of preventing a rapid change in discharge power.

Next, in Step S106, the system controller 101 determines whether the current discharge power instruction value of each of the storage battery strings STR1 to STRm reaches the target discharge power instruction value of each of the storage battery strings STR1 to STRm. When NO is determined in Step S106, the process transitions to Step S104. When YES is determined in Step S106, the process transitions to Step S102.

When the storage battery strings STR1 to STRm where the discharge power instruction value is the discharge power limit value or higher are present, the loop process of Steps S104 to S106 is repeatedly executed until the discharge power instruction value of the corresponding storage battery strings STR1 to STRm falls below the discharge power limit value. Here, in Steps S104 to S106, the discharge power instruction value of each of the storage battery strings STR1 to STRm changes from the current value to the target value gradually and continuously by the predetermined amount ΔP3.

Next, in Step S107, the system controller 101 an instruction value of output power of the entire power storage system 1 (hereinafter, referred to as the output power instruction value) from the higher-ranking system. Next, in Step S108, the system controller 101 determines whether the output power instruction value acquired in Step S107 is updated from the previously acquired output power instruction value. When YES is determined in Step S108, the process transitions to Step S109. When NO is determined in Step S108, the process ends.

In Step S109, the system controller 101 determines the priorities of the storage battery strings STR1 to STRm to which the discharge power instruction values are assigned depending on the state of each of the storage battery strings STR1 to STRm. Next, in Step S110, the system controller 101 calculates and determines the target value of discharge power of each of the storage battery strings STR1 to STRm (hereinafter, referred to as the target discharge power instruction value) depending on the priorities determined in Step S109. That is, the system controller 101 assigns a higher target discharge power instruction value to the storage battery strings STR1 to STRm having a higher priority.

Next, the system controller 101 repeatedly executes the loop process of Steps S111 to S113 until the discharge power instruction value reaches the target discharge power instruction value. Here, in Steps S111 to S113, the system controller 101 changes the discharge power instruction value of each of the storage battery strings STR1 to STRm from the current value to the target value gradually and continuously by a predetermined amount ΔP4.

First, in Step S111, the system controller 101 calculates the predetermined amount ΔP4 and updates the discharge power instruction value of each of the storage battery strings STR1 to STRm. The predetermined amount ΔP4 is a value obtained by equally dividing a difference between the target discharge power instruction value of each of the storage battery strings STR1 to STRm determined in Step S110 and the current discharge power instruction value. Here, the number of times the difference is equally divided is set such that the calculated predetermined amount ΔP4 satisfies the object of preventing a rapid change in discharge power.

Next, in Step S112, the system controller 101 waits for a predetermined period of time T4 from the transmission of the discharge power instruction value to the string controllers C1 to Cm. The predetermined period of time T4 is set considering a period of time required for the control of the discharge power of the storage battery strings STR1 to STRm by the string controllers C1 to Cm and a change rate of discharge power. Here, the change rate of discharge power is set to be low to satisfy the object of preventing a rapid change in discharge power.

Next, in Step S113, the system controller 101 determines whether the current discharge power instruction value of each of the storage battery strings STR1 to STRm reaches the target discharge power instruction value of each of the storage battery strings STR1 to STRm. When NO is determined in Step S113, the process transitions to Step S111. When YES is determined in Step S113, the process ends.

As described above, when the storage battery control device 100 according to the embodiment is instructed to update the input power instruction value of the entire power storage system 1 from the higher-ranking system, the charge power instruction value of each of the storage battery strings STR1 to STRm changes from the current value to the target charge power instruction value. Here, the storage battery control device 100 repeatedly executes the process of changing the charge power instruction value of each of the storage battery strings STR1 to STRm to the target charge power instruction value by the predetermined amount ΔP1 or ΔP2 until the charge power instruction value reaches the target charge power instruction value. Here, the predetermined amount ΔP1 or ΔP2 is less than the difference between the target charge power instruction value and the current value. As a result, when the charge power instruction value of each of the storage battery strings STR1 to STRm changes from the current value to the target charge power instruction value, a rapid change in charge power in the storage battery strings STR1 to STRm can be prevented, and the target charge power as the power storage system 1 can be maintained. “Charge power” may be replaced with “charge current”. Even then, likewise, a rapid change in charge current in the storage battery strings STR1 to STRm can be prevented, and the target charge current as the power storage system 1 can be maintained.

When the storage battery control device 100 according to the embodiment is instructed to update the output power instruction value of the power storage system 1 from the higher-ranking system, the discharge power instruction values of the storage battery strings STR1 to STRm change from the current value to the target discharge power instruction value. Here, the storage battery control device 100 repeatedly executes the process of changing the discharge power instruction value of each of the storage battery strings STR1 to STRm to the target discharge power instruction value by the predetermined amount ΔP3 or ΔP4 until the discharge power instruction value reaches the target discharge power instruction value. Here, the predetermined amount ΔP3 or ΔP4 is less than the difference between the target discharge current instruction value and the current value. As a result, when the discharge power instruction value of each of the storage battery strings STR1 to STRm changes from the current value to the target discharge power instruction value, a rapid change in discharge current in the storage battery strings STR1 to STRm can be prevented, and the target discharge power as the power storage system 1 can be maintained. “Discharge power” may be replaced with “discharge current”. Even then, likewise, a rapid change in discharge current in the storage battery strings STR1 to STRm can be prevented, and the target discharge current as the power storage system 1 can be maintained.

In the storage battery control device 100 according to the embodiment, when the charge power instruction value of each of the storage battery strings STR1 to STRm changes from the current value to the target charge power instruction value, the target charge power instruction value is set to be lower than the charge power limit value of each of the storage battery strings STR1 to STRm. As a result, even when the charge power limit value varies depending on the storage battery strings STR1 to STRm, the charge power of each of the storage battery strings STR1 to STRm can be prevented from exceeding the charge power limit value. In particular, the storage battery control device 100 according to the embodiment determines whether the current value of the charge power instruction value of each of the storage battery strings STR1 to STRm is the charge power limit value or more. When the storage battery control device 100 determines that the current value of the charge power instruction value of each of the storage battery strings STR1 to STRm is the charge power limit value or more, the storage battery control device 100 sets the target charge power instruction value of each of the storage battery strings STR1 to STRm such that the target charge power instruction value is lower than the charge power limit value. That is, when the state of the storage battery strings STR1 to STRm changes such that the charge power limit value changes, the charge power instruction value of the corresponding storage battery strings STR1 to STRm changes to be lower than the charge power limit value. As a result, the storage battery strings STR1 to STRm can always operate in the range of the charge power limit value. “Charge power” may be replaced with “charge current”. Even then, likewise, the storage battery strings STR1 to STRm can always operate in the range of the charge current limit value.

In the storage battery control device 100 according to the embodiment, when the discharge power instruction value of each of the storage battery strings STR1 to STRm changes from the current value to the target discharge power instruction value, the target discharge power instruction value is set to be lower than the discharge power limit value of each of the storage battery strings STR1 to STRm. As a result, even when the discharge power limit value varies depending on the storage battery strings STR1 to STRm, the discharge power of each of the storage battery strings STR1 to STRm can be prevented from exceeding the discharge power limit value. In particular, the storage battery control device 100 according to the embodiment determines whether the current value of the discharge power instruction value of each of the storage battery strings STR1 to STRm is the discharge power limit value or more. When the storage battery control device 100 determines that the current value of the discharge power instruction value of each of the storage battery strings STR1 to STRm is the discharge power limit value or more, the storage battery control device 100 sets the target discharge power instruction value of each of the storage battery strings STR1 to STRm such that the target discharge power instruction value is lower than the discharge power limit value. That is, when the state of the storage battery strings STR1 to STRm changes such that the discharge power limit value changes, the discharge power instruction value of the corresponding storage battery strings STR1 to STRm changes to be lower than the discharge power limit value. As a result, the storage battery strings STR1 to STRm can always operate in the range of the discharge power limit value. “Discharge power” may be replaced with “discharge current”. Even then, likewise, the storage battery strings STR1 to STRm can always operate in the range of the discharge current limit value.

In the storage battery control device 100 according to the embodiment the predetermined priority is set depending on the state of each of the storage battery strings STR1 to STRm, and as the predetermined priority of each of the storage battery strings STR1 to STRm becomes higher, the target charge power instruction value is set to be higher. The predetermined priority is set to be higher, for example, as the cumulative charge/discharge capacity of each of the storage battery strings STR1 to STRm decreases or as the SOH of each of the storage battery strings STR1 to STRm increases. The predetermined priority is randomly set, for example, whenever the charge power instruction value changes. As a result, when one of the storage battery strings STR1 to STRm is intensively charged, deterioration of the corresponding storage battery strings STR1 to STRm can be prevented from progressing relatively rapidly. “Charge power” may be replaced with “charge current”. Even then, likewise, when one of the storage battery strings STR1 to STRm is intensively charged, deterioration of the corresponding storage battery strings STR1 to STRm can be prevented from progressing relatively rapidly.

In the storage battery control device 100 according to the embodiment the predetermined priority is set depending on the state of each of the storage battery strings STR1 to STRm, and as the predetermined priority of each of the storage battery strings STR1 to STRm becomes higher, the target discharge power instruction value is set to be higher. The predetermined priority is set to be higher, for example, as the cumulative charge/discharge capacity of each of the storage battery strings STR1 to STRm decreases or as the SOH of each of the storage battery strings STR1 to STRm increases. The predetermined priority is randomly set, for example, whenever the discharge power instruction value changes. As a result, when one of the storage battery strings STR1 to STRm is intensively discharged, deterioration of the corresponding storage battery strings STR1 to STRm can be prevented from progressing relatively rapidly. “Discharge power” may be replaced with “discharge current”. Even then, likewise, when one of the storage battery strings STR1 to STRm is intensively discharged, deterioration of the corresponding storage battery strings STR1 to STRm can be prevented from progressing relatively rapidly.

In the storage battery control device 100 according to the embodiment, the target charge power instruction value or the target discharge power instruction value is set for the plurality of storage battery strings STR1 to STRm, and the charge power instruction value or the discharge power instruction value changes from the current value to the target value simultaneously in the plurality of storage battery strings STR1 to STRm. Here, in the storage battery control device 100, the process of changing the charge power instruction value or the discharge power instruction value of each of the storage battery strings STR1 to STRm to the target value by the small amount of change that is less than the difference between the target value and the current value is repeatedly executed until the charge power instruction value or the discharge power instruction value reaches the target value. As a result, the input/output power as the power storage system 1 can be gradually and continuously changed from the current value to the target value. The total input/output power of all of the storage battery strings STR1 to STRm only needs to change to the target value of the power storage system 1, and the storage battery strings STR1 to STRm in the charge state the storage battery strings STR1 to STRm in the discharge state may be mixed.

Hereinabove, the present disclosure has been described based on the embodiment. However, the present disclosure is not limited to the above-described embodiment. Within a range not departing from the scope of the present disclosure, changes may be made or combinations with well-known or commonly known techniques may be made.

For example, in the above-described embodiment, by monitoring the limit value of charge power or charge current of the storage battery strings STR1 to STRm, the remaining charge capacity until the upper limit threshold of the string SOC is monitored. Accordingly, by setting the charge power or the charge current of the storage battery strings STR1 to STRm such that the charge power or the charge current falls below the limit value of charge power or charge current, the charge power or the charge current is assigned to the storage battery strings STR1 to STRm where the remaining charge capacity until the upper limit threshold of the string SOC is present. However, using the storage battery control device 100, whether the remaining charge capacity until the upper limit threshold of the string SOC is present may be determined to assign the instruction value of charge power or charge current to the storage battery strings STR1 to STRm where the remaining charge capacity until the upper limit threshold of the string SOC is present.

Likewise, in the above-described embodiment, by monitoring the limit value of discharge power or discharge current of the storage battery strings STR1 to STRm, the remaining discharge capacity until the lower limit threshold of the string SOC is monitored. Accordingly, by setting the discharge power or the discharge current of the storage battery strings STR1 to STRm such that the discharge power or the discharge current falls below the limit value of discharge power or discharge current, the discharge power or the discharge current is assigned to the storage battery strings STR1 to STRm where the remaining discharge capacity until the lower limit threshold of the string SOC is present. However, using the storage battery control device 100, whether the remaining discharge capacity until the upper limit threshold of the string SOC is present may be determined to assign the instruction value of discharge power or discharge current to the storage battery strings STR1 to STRm where the remaining discharge capacity until the lower limit threshold of the string SOC is present.

In the above-described embodiment, the system controller 101 transmits the instruction value of charge/discharge power or charge/discharge current to the string controllers C1 to Cm. However, the system controller 101 and the string controllers C1 to Cm may be integrated with each other, and the integrated controller may set the instruction value of charge/discharge power or charge/discharge current of each of the storage battery strings STR1 to STRm. Here, in Step S4 and Step S10 of FIG. 4, in addition to the waiting for the predetermined period of time T1 or the predetermined period of time T2, the charge power control of the storage battery strings STR1 to STRm by the controller is executed. In Step S104 and Step S110 of FIG. 7, in addition to the waiting for the predetermined period of time T3 or the predetermined period of time T4, the discharge power control of the storage battery strings STR1 to STRm by the controller is executed.

According to a first aspect of the present disclosure, there is provided a storage battery control device (100) that controls a power storage system (1) including a plurality of storage battery strings (STR1 to STRm) connected in parallel to each other, each of the storage battery strings including a plurality of storage batteries (M1 to Mn) connected in series and a power converter (one of PC1 to PCm) configured to convert an input/output power of the storage battery string (one of STR1 to STRm), in which: an instruction value of power or current of charge or discharge of the storage battery string is set; and when the instruction value changes from a current value to a target value, a process of changing the instruction value to the target value by a small amount of change that is less than a difference between the target value and the current value is repeatedly executed until the instruction value reaches the target value.

According to a second aspect of the present disclosure, the target value may be set to be lower than a limit value of power or current of charge or discharge of the storage battery string.

According to a third aspect of the present disclosure, whether the current value is the limit value or higher is determined, and when it is determined that the current value is the limit value or higher, the instruction value may be changed to a value lower than the limit value.

According to a fourth aspect of the present disclosure, a predetermined priority may be set depending on a state of the storage battery string, and as the predetermined priority of the storage battery string becomes higher, the target value may be set to be higher.

According to a fifth aspect of the present disclosure, the predetermined priority may be set to be higher as a cumulative charge/discharge capacity of the storage battery string decreases or set to be higher as a SOH of the storage battery string increases.

According to a sixth aspect of the present disclosure, the predetermined priority may be randomly set whenever the instruction value changes from the current value to the target value.

According to a seventh aspect of the present disclosure, the instruction value may be set for the plurality of storage battery strings, and when the instruction value changes from the current value to the target value simultaneously in the plurality of storage battery strings, a process of changing the instruction value to the target value by a small amount of change that is less than a difference between the target value and the current value may be repeatedly executed until the instruction value reaches the target value.

According to an eighth aspect of the present disclosure, there is provided a power storage system (1) including: a plurality of storage battery strings (STR1 to STRm) connected in parallel to each other; and a storage battery control device configured to control the storage battery strings (STR1 to STRm), in which each of the storage battery strings includes: a plurality of storage batteries (M1 to Mn) connected in series; and a power converter (one of PC1 to PCm) configured to convert an input/output power of the storage battery string (one of STR1 to STRm); and in the storage battery control device, an instruction value of power or current of charge or discharge of the storage battery string is set, and when the instruction value changes from a current value to a target value, a process of changing the instruction value to the target value by a small amount of change that is less than a difference between the target value and the current value is repeatedly executed until the instruction value reaches the target value.

According to a ninth aspect of the present disclosure, there is provided a storage battery control method that is executed by a storage battery control device for controlling a power storage system (1) including a plurality of storage battery strings (STR1 to STRm) connected in parallel to each other, each of the storage battery strings including a plurality of storage batteries (M1 to Mn) connected in series and a power converter (one of PC1 to PCm) configured to convert an input/output power of the storage battery string (one of STR1 to STRm), the storage battery control method including: setting an instruction value of power or current of charge or discharge of the storage battery string; and repeatedly executing a procedure of changing the instruction value to a target value by a small amount of change that is less than a difference between the target value and the current value until the instruction value reaches the target value when the instruction value changes from a current value to the target value.

According to the aspects of the present disclosure, in a power storage system where a plurality of storage battery strings are connected in parallel, a current change when an instruction value of power or current of charge or discharge of each of the storage battery strings is changed can be prevented and a target charge/discharge power as the power storage system can be maintained.

What is claimed is:

1. A storage battery control device that controls a power storage system including a plurality of storage battery strings connected in parallel to each other, each of the storage battery strings including a plurality of storage batteries connected in series and a power converter configured to convert an input/output power of the storage battery string, wherein:
an instruction value of power or current of charge or discharge of the storage batteries string is set; and
when the instruction value changes from a current value to a target value, a process of changing the instruction value to the target value by a small amount of change that is less than a difference between the target value and the current value is repeatedly executed until the instruction value reaches the target value.

2. The storage battery control device according to claim 1, wherein
the target value is set to be lower than a limit value of power or current of charge or discharge of the storage battery string.

3. The storage battery control device according to claim 2, wherein
whether the current value is the limit value or higher is determined, and when it is determined that the current value is the limit value or higher, the instruction value is changed to a value lower than the limit value.

4. The storage battery control device according to claim 1, wherein:
a predetermined priority is set depending on a state of the storage battery string; and
as the predetermined priority of the storage battery string becomes higher, the target value is set to be higher.

5. The storage battery control device according to claim 4, wherein
the predetermined priority is set to be higher as a cumulative charge/discharge capacity of the storage battery string decreases or is set to be higher as a SOH of the storage battery string increases.

6. The storage battery control device according to claim 4, wherein
the predetermined priority is randomly set whenever the instruction value changes from the current value to the target value.

7. The storage battery control device according to claim 1, wherein:
the instruction value is set for the plurality of storage battery strings; and
when the instruction value changes from the current value to the target value simultaneously in the plurality of storage battery strings, a process of changing the instruction value to the target value by a small amount of change that is less than a difference between the target value and the current value is repeatedly executed until the instruction value reaches the target value.

8. A power storage system comprising:
a plurality of storage battery strings connected in parallel to each other; and
a storage battery control device configured to control the storage battery strings, wherein
each of the storage battery strings includes: a plurality of storage batteries connected in series; and a power converter configured to convert an input/output power of the storage battery string; and
in the storage battery control device, an instruction value of power or current of charge or discharge of the storage battery string is set, and when the instruction value changes from a current value to a target value, a process of changing the instruction value to the target value by a small amount of change that is less than a difference between the target value and the current value is repeatedly executed until the instruction value reaches the target value.

9. A storage battery control method that is executed by a storage battery control device for controlling a power storage system including a plurality of storage battery strings connected in parallel to each other, each of the storage battery strings including a plurality of storage batteries connected in series and a power converter configured to convert an input/output power of the storage battery string, the storage battery control method comprising:
setting an instruction value of power or current of charge or discharge of the storage battery string; and
repeatedly executing a procedure of changing the instruction value to a target value by a small amount of change that is less than a difference between the target value and the current value until the instruction value reaches the target value when the instruction value changes from a current value to the target value.
